(19) United States
(12) Patent Application Publication
(10) Pub. No.: US 2004/0260850 A1
(43) Pub. Date: Dec. 23, 2004

(54) Apparatus for USB interface identification

(75) Inventors: Ta-Lung Yu, Taipei (TW); Hsien-Jung Li, Taipei (TW); Wen-Pin Chen, Keelung (TW); Chi-Neng Huang, I-Lan Hsien (TW)

Correspondence Address: BRUCE H. TROXELL, SUITE 1404, 5205 LEESBURG PIKE, FALLS CHURCH, VA, 22041, US

(73) Assignee: Action Star Enterprise Co., Ltd.

(21) Appl. No.: 10/462,627

(22) Filed: Jun. 17, 2003

(51) Int. Cl. G06F 13/00; G06F 3/00

(52) U.S. Cl. 710/104; 710/16; 710/313

(57) ABSTRACT

The present invention is related to a device for USB interface identification, wherein a universal serial bus (USB) connection interface is installed on one side of computer exterior as a connection for external electronic apparatus, and more specifically, the present invention installs a decision circuit connecting to a display device between the USB connection interface and the electronic apparatus. Thus, messages illustrated on the display device are employed by user to determine whether the transmission speed between the computer and the electronic apparatus is in the low speed, full speed, or hi-speed.

### BACKGROUND OF THE INVENTION

(a). Field of the Invention

The present invention is related to an apparatus for USB interface identification, and more specifically, to an apparatus, wherein a decision circuit connecting to a display device is installed between the USB connection interface and a electronic apparatus, and messages illustrated on the display device are employed by user to determine whether the transmission speed between the computer and the electronic apparatus is in the low speed, full speed, or hi-speed.

(b). Description of the Prior Arts

Conventionally, computer peripherals adopt RS232, PS2 mostly as interface for coupling. However, along with the increase of host computer's processing speed, when host computer cooperates with the above computer peripherals, the overall processing speed will be affected often because the performance of the computer peripherals can't catch up with the host computer. Therefore, researchers in the field work zealously for the development of new transmission interface to conform to the need for upgrading total computer performance. Consequently, a new generation of computer transmission interface comes into being, that is, in the wired transmission interfaces, comprising: universal serial bus (UBS) and IEEE 1394, etc. Among which, the interface transmission speed of the earliest USB v.1.0 is 1.5 Mbps, but the transmission speed of USB v.1.1 already can be as fast as 12 Mbps. Furthermore, the transmission speed of USB v.2.0 can reach 480 Mbps, which is 40 times of its previous version. Thus, it further establishes the status of USB as dominating transmission interface of new generation computer. Nevertheless, during the interchange process between the old version of USB interface and the new version of USB interface, it is difficult for user to know which version of USB interface is used in its host computer. The present invention is an apparatus that can determine the version of USB interface employed in host computer by using a simply display device, so that the specification of USB can be easily identified and mastered by users.

### SUMMARY OF THE INVENTION

To solve the aforementioned drawbacks of the prior arts, the present invention provides an apparatus for USB interface identification. The main objective of the present invention is to install a universal serial bus (USB) connection interface on one side of computer exterior as a connection for external electronic apparatus, and more specifically, a decision circuit connecting to a display device is installed between the USB connection interface and the electronic apparatus according to the present invention. Thus, messages illustrated on the display device are employed by user to determine whether the transmission speed between the computer and the electronic apparatus is in the low speed, full speed, or hi-speed.

In a preferred embodiment, the decision circuit uses an amplitude variation of. (D+, D−) signal transmitted by USB to ascertain the USB's transmission speed and transfers a result of decision to a display device.

For your esteemed members of reviewing committee to further understand and recognize the objectives, the characteristics, and the functions of the invention, a detailed description in matching with corresponding drawings are presented as the following:

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram depicting the connection of function blocks of the USB interface identification apparatus according to the present invention.

FIG. 2 is a diagram depicting the relation between USB signal (D+, D−) and USB transmission speed.

FIG. 3 is a diagram depicting an embodiment of architecture for decision circuit according to the present invention.

FIG. 4A is the first embodiment drawing of a cable installed with the USB interface identification apparatus of the present invention.

FIG. 4B is the second embodiment drawing of a cable installed with the USB interface identification apparatus of the present invention.

FIG. 5A is the first embodiment drawing of a hub installed with the USB interface identification apparatus of the present invention.

FIG. 5B is the second embodiment drawing of a hub installed with the USB interface identification apparatus of the present invention.

### DETAILED DESCRIPTION OF THE PRESENT INVENTION

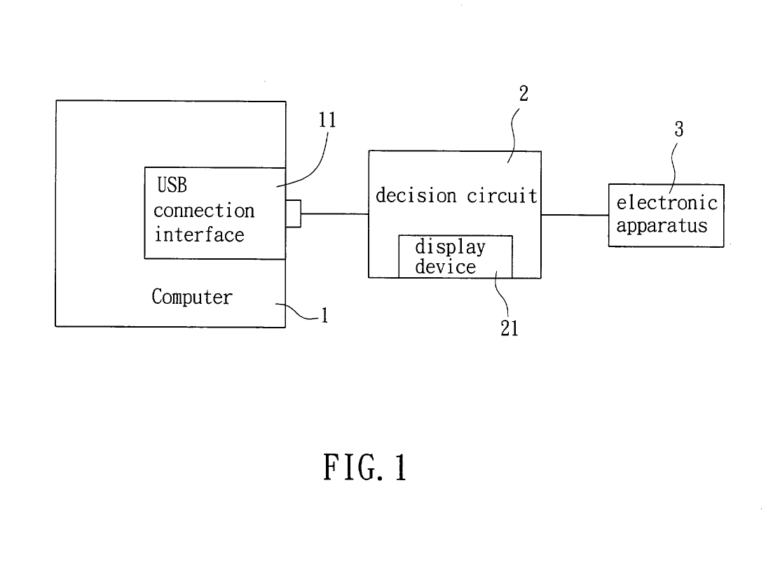

Please refer to FIG. 1, which is a schematic diagram depicting the connection of function blocks of the USB interface identification apparatus according to the present invention, wherein, a USB connection interface 11 comprising 2 to 4 ports is installed on one side of computer exterior as a connection for external electronic apparatus 3, and more specifically, a decision circuit 2 connecting to a display device 21 is installed between the USB connection interface 11 and the electronic apparatus 3 according to the present invention. Thus, messages illustrated on the display device 21 are employed by user to ascertain the transmission speed between computer 1 and the lectronic apparatus 3. The action principle of the decision circuit 2 is based on the amplitude variation of USB transmitted signal, that is, when the speed of (D+, D−) signal transmitted by USB is in the hi-speed, the amplitude thereof is comparatively lower; on the contrary, when the speed of (D+, D−) signal transmitted by USB is in the low speed, the amplitude thereof is comparatively higher. With this principle, it is possible to use a simple logic circuit to detect amplitude of the USB signal and therefore divides the USB transmission speed into low-speed, full-speed and hi-speed. Among which, the low-speed is used in interfaces using USB v. 1.0, wherein the range of the low-speed is under 5 Mbps; the full-speed is used in interfaces using USB v. 1.1, wherein the range of the full-speed is around 12 Mbps; Comparatively, the hi-speed is used in interfaces using USB v. 2.0, wherein the range of the hi-speed is 480 Mbps more or less.

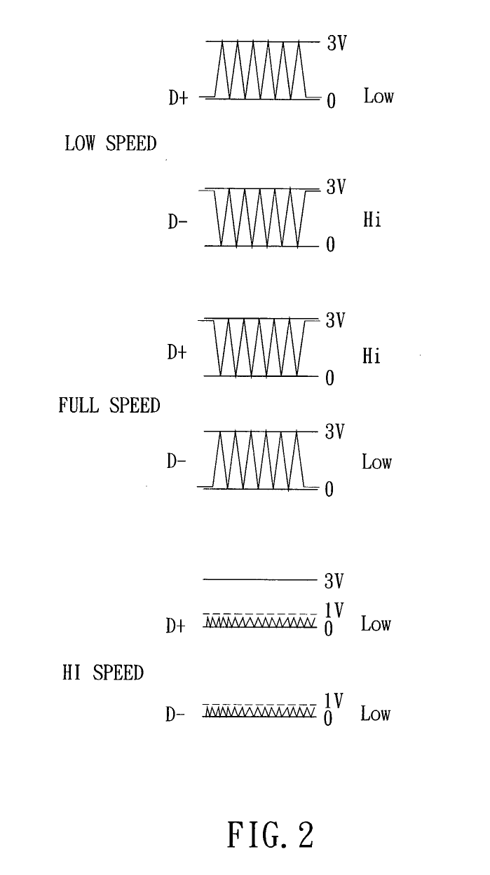

Please refer to FIG. 2, which is a diagram depicting the relation between the USB signal (D+, D−) and the USB transmission speed. The signal amplitude variation states used by the decision circuit 2, as seen in FIG. 1, to determine the transmission speed of USB can be separated into the following:

(1) When USB transmission speed is the low-speed, its D+ signal line is in no-signal state and its D− signal line is in hi-signal state (that is, oscillating between 0˜3 V).

(2) When USB transmission speed is in the full-speed, its D+ signal line is in hi-signal state (that is, oscillating between 0˜3 V) and its D− signal line is in no-signal state.

(3). When USB transmission speed is in the hi-speed, its D+ signal line is in low signal state (that is, oscillating between 0˜1 V) and its D− signal line is also in low signal state (that is, oscillating between 0˜1 V).

Three logical statuses are acquired from the above three states by using the inner logic circuit of the decision circuit 2 to differentiate every states of D+ and D− from each other. The three logical statuses are displayed using the display devices illustrated in the following figures.

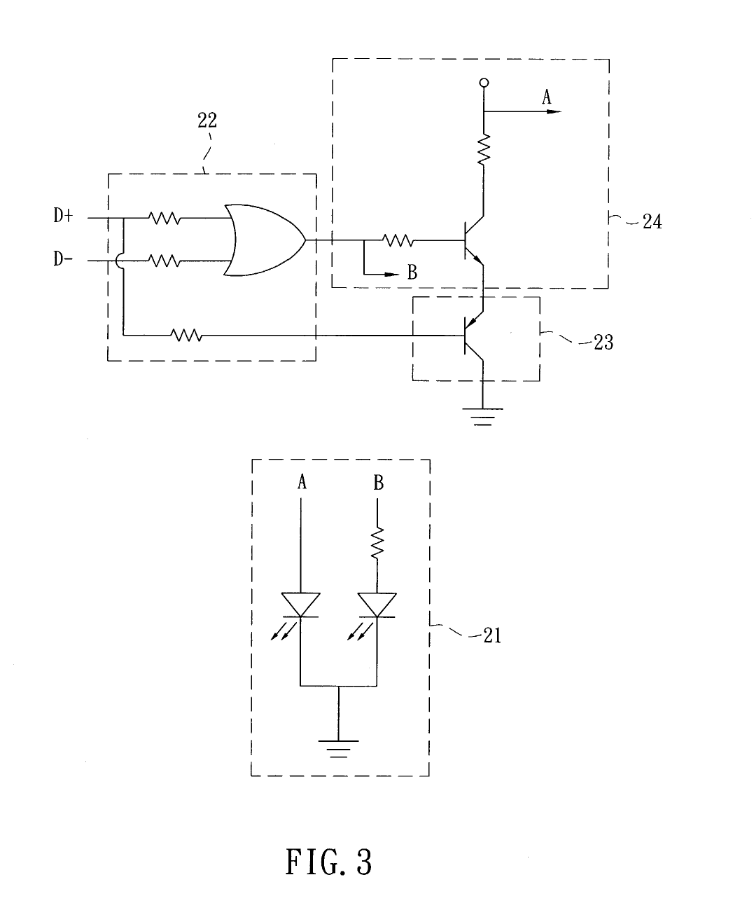

To clarify the technical means of the present invention, the detailed architecture of decision circuit 2 illustrated in FIG. 1 is further discussed in more detail. Please refer to FIG. 3, which is an embodiment of architecture for the decision circuit. Those skilled in the art should appreciate that the same effect can be achieved using a driving program, and the spirit of the present invention is also fulfilled, if the effect can be illustrated using the function block of FIG. 3. FIG. 3 is a composition of several passive devices cooperating with a logic gate (or gate), and can be distinguished by mean of function block. The function blocks comprise: a display device 21, a signal reading device 22, a comparator 24 and a driving unit 24. A detailed description of function blocks is as following:

Signal reading device 22: Please refer to FIG. 2, which is a relation chart depicting the relation between the USB signal D+ and D−, and the USB transmission speed is illustrated as following:

| | State of the | State of the | |
|---|---|---|---|
| | first transmitted | transmitted second | Transmission |
| | signal (D+) | signal (D+) | Speed |
| USB 1.0 | LOW | HI | LOW-SPEED |
| USB 1.1 | HI | LOW | FULL-SPEED |
| USB 2.0 | LOW | LOW | HI-SPEED |

Through the evaluation of the above signal reading device, the transmitted signal can be divided into three status: low-speed, full-speed and hi-speed.

Comparator 23: according to voltage levels of the two transmitted signals D+ and D− to determine whether an electronic apparatus is connected or not, and to ascertain version of USB interface, comprising the following three states:

(a) When connecting with no electronic apparatus, the outputting voltage levels thereof will be in the LOW state.

(b) When connecting with an electronic apparatus and if the transmitting speed is within USB v.1.0 range, the outputting voltage levels thereof will be in the HI state.

(c) When connecting with an electronic apparatus and if the transmitting speed is within USB v.1.1 range, the outputting voltage levels thereof will be in the LOW state.

(d) When connecting with an electronic apparatus, and if the transmitting speed is within USB v.2.0 range, than the two transmitted signals D+ and D− will be outputted directly by a NOT gate that without passing through the comparator 23 for evaluation.

Driving part 24: according to the output states of the signal reading device 22 and the comparator 23, the driving part 23 drives a display device 21 which in the present embodiment is a formation of two light emitting diode (LED), A and B, to achieve objective of easy to identify the transmission speed and the version of the USB interface used by user.

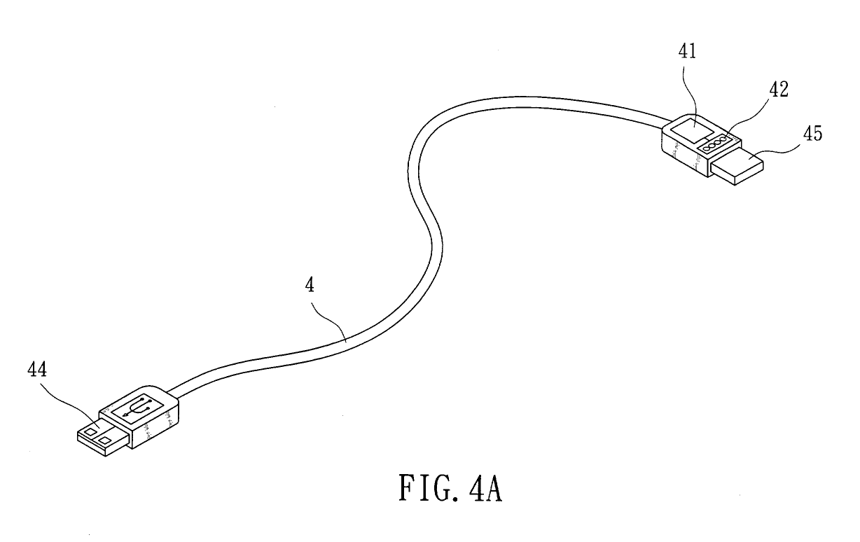

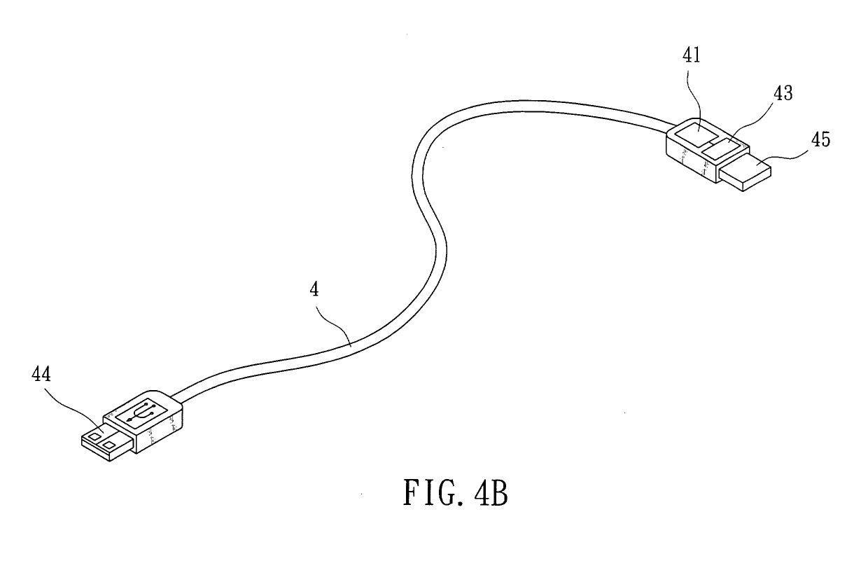

Please refer to FIG. 4A, which is the first embodiment drawing of a cable installed with the USB interface identification apparatus of the present invention, wherein the decision circuit can be installed inside USB transmission cable 4. As seen in FIG. 4A, the two ends of the cable 4 respectively are the computer connection end 44 and the electronic apparatus connection end 45, moreover, for making it easy to read by user, the decision circuit 41 and the signal light 42 are both installed near user at the electronic apparatus connection end 45. The signal light 42 can be a formation of LED that receives signals transmitted from the decision circuit 41 and use three different colors to distinguish between transmission speeds (e.g. “red” stands for hi-speed, “orange” stands for full-speed, “green” stands for low-speed) to achieve functions of simplicity and easy-to-recognize.

Please refer to FIG. 4B, which is the second embodiment drawing of a cable installed with the USB interface identification apparatus of the present invention, wherein the decision circuit can be installed inside the USB transmission cable 4 and connects to a display screen 43 formed out of LCD. The screen 43 can display transmission speed of the decision circuit using numbers or characters, for example: when the transmission speed is low-speed, a sketch of “1” or “LOW” is shown on the display screen 43; when transmission speed is full-speed, a sketch of “2” or “FULL” is shown on the display screen 43; when transmission speed is hi-speed, a sketch of “3” or “HIGH” is shown on the display screen 43, etc. that can also achieve functions of simplicity and easy-to-recognize.

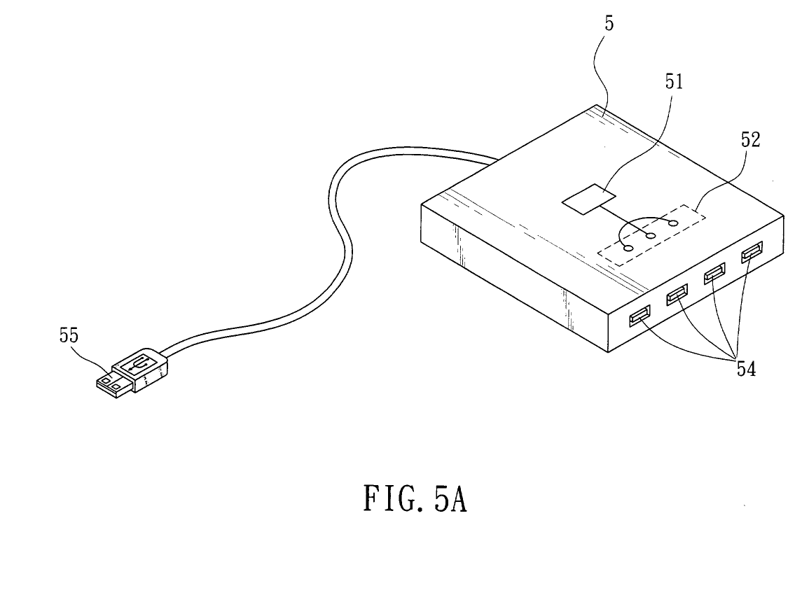

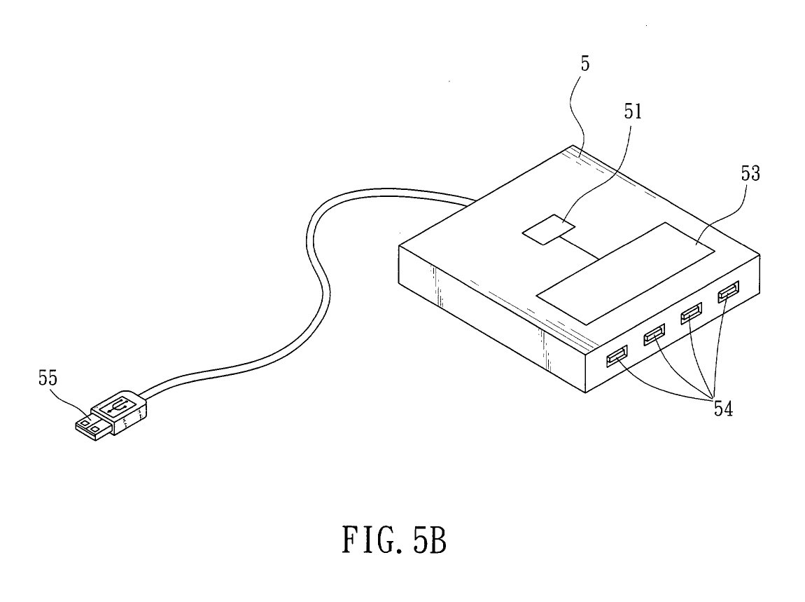

Please refer to FIGS. 5A and 5B, which is the first and second embodiment drawing of a hub installed with the USB interface identification apparatus of the present invention. The spirits of these present embodiments are no more then using an USB electronic apparatus for identifying USB interface, wherein a component with decision circuit 51, signal light 52, USB connection port 54 and computer connection end 55 is install inside the USB hub 5. In FIG. 5A, the transmission speed is shown to user by the signal light 53 on the surface of the USB hub 5. In FIG. 5B, the transmission speed is shown to user by the display screen 53 formed out of LCD on the surface of the USB hub 5. The embodiments use plain and clear display structures to inform users that the transmission speed between the computer and the USB hub 5, 5 so that users can grasp the working status of USB electronic apparatus at any time.

In summary that this invention has been disclosed and illustrated with reference to particular embodiments, the principles involved are susceptible for use in numerous other embodiments that will be apparent to persons skilled in the art. Consequently, the present invention has been examined to be progressive and has great potential in commercial applications.

Those skilled in the art should appreciate that they can readily use the disclosed conception and specific embodiments as a basis for designing or modifying other structures for carrying out the same purpose of the present invention, and that various changes, substitutions and alterations can be made herein without departing from the spirit and scope of the invention as defined by the append claims.

What is claimed is

1. A device for USB interface identification, comprising:
a computer, that a USB connection interface is installed on one side thereof
a cable whose one end is coupled to said USB connection interface of said computer;
a decision circuit installed inside the other end of said cable is coupled to a display device installed within said cable; and
wherein said decision circuit uses an amplitude variation of(D+, D−) signal transmitted by USB to ascertain said USB's transmission speed and transfers a result of decision to the display device.

2. The device for USB interface identification as recited in claim 1, wherein said transmission speed of said USB can be one of the following: low-speed, full-speed, and hi-speed.

3. The device for USB interface identification as recited in claim 2, wherein: when said transmission speed of said USB is in the low-speed, said USB's D+ signal line is in a low level state and said USB's D− signal line is in a high level state.

4. The device for USB interface identification as recited in claim 3, wherein: when said transmission speed of said USB is in the low-speed, said low-speed is below 1.5 Mbps.

5. The device for USB interface identification as recited in claim 2, wherein: when said transmission speed of said USB's is in the full-speed, said USB's D+ signal line is in a high level state said USB D− signal line is in a low level state.

6. The device for USB interface identification as recited in claim 5, wherein: when said transmission speed of said USB is in the full-speed, said full-speed is 12 Mbps.

7. The device for USB interface identification as recited in claim 2, wherein: when said transmission speed of said USB is in the hi-speed, said USB's D+ signal line is in a low level state (that is, oscillating between 0˜1 V) and said USB's D− signal line is also in the low level state (that is, oscillating between 0˜1 V).

8. The device for USB interface identification as recited in claim 7, wherein: when said transmission speed of said USB is in the hi-speed, said hi-speed is 480 Mbps.

9. The device for USB interface identification as recited in claim 1, wherein said display device is formed with a plurality of LEDs, so that different transmission speed can be distinguished by using LED with different color.

10. The device for USB interface identification as recited in claim 1, wherein said display device is a L CD that the transmission speed o f said decision circuit can be displayed by using numbers or characters.

11. The device for USB interface identification as recited in claim 1, wherein said decision circuit is a logic circuit for detecting said amplitude variation of (D+, D−) signal transmitted by USB.

12. A device for USB interface identification, comprising:
a computer, that a USB connection interface is installed on one side thereof;
a hub, whose computer connection end is coupled to the USB connection interface of said computer;
a decision circuit installed inside said hub is coupled to a display device installed on the surface of said hub; and
wherein the decision circuit uses an amplitude variation of (D+, D−) signal transmitted by USB to ascertain said USB's transmission speed and transfers a result of decision to the display device.

13. The device for USB interface identification as recited in claim 12, wherein said transmission speed of said USB can be one of: low-speed, full-speed, and hi-speed.

14. The device for USB interface identification as recited in claim 13, wherein: when said transmission speed of said USB is in the low-speed said USB's D+ signal line is in a low state and said USB's D− signal line is in a high level state (that is, oscillating between 0˜3 V).

15. The device for USB interface identification as recited in claim 14, wherein: when said transmission speed of said USB is in the low-speed, said low-speed is below 1.5 Mbps.

16. The device for USB interface identification as recited in claim 12, wherein: when said transmission speed of said USB is in the full-speed said USB's D+ signal line is in a high level state said USB's D− signal line is in a low level state.

17. The device for USB interface identification as recited in claim 16, wherein: when said transmission speed of said USB is in the full-speed, said full-speed is 12 Mbps.

18. The device for USB interface identification as recited in claim 12, wherein: when said transmission speed of said USB is in the hi-speed, said USB's D+ signal line is in a low level state (that is, oscillating between 0˜1 V) and said USB's D− signal line is also in a low level state (that is, oscillating between 0˜1 V).

19. The device for USB interface identification as recited in claim 18, wherein: when said transmission speed of said USB is in the hi-speed, said hi-speed is 480 Mbps.

20. The device for USB interface identification as recited in claim 12, wherein said display device is formed with a plurality of LEDs, so that different transmission speed can be distinguished by using LED with different color.

21. The device for USB interface identification as recited in claim 12, wherein said display device is a LCD that the transmission speed of said decision circuit can be displayed by using numbers or characters.

22. The device for USB interface identification as recited in claim 12, wherein said decision circuit is a logic circuit for detecting the amplitude variation of (D+, D−) signal transmitted by USB.

23. A decision circuit for USB interface identification device, comprising:
a signal reading device, by which a transmission speed of an USB interface is ascertained according to the corresponding state of two transmitted signals D+and D−;
a comparator using voltage levels of the two transmitted signals D+ and D− to determine whether an electronic apparatus is connected or not, and to ascertain version of USB interface; and
a driving part, which drives a display device according to output states of said signal reading device and said comparator.

24. The decision circuit for USB interface identification device as recited in claim 23, wherein said transmission speed of said USB can be one of: low-speed, full-speed, and hi-speed.
